(19) United States
(12) Patent Application Publication
(10) Pub. No.: US 2006/0087133 A1
(43) Pub. Date: Apr. 27, 2006

(54) Device for the collection and disposal of animal waste

(76) Inventor: Keith Edward Bomgesser, Brookfield, WI (US)

Correspondence Address: Richard S. Missimer, 2218 S Sanctuary Drive, P.O.Box 511224, New Berlin, WI, 53151, US

(21) Appl. No.: 10/970,970

(22) Filed: Oct. 21, 2004

(51) Int. Cl. A01K 29/00

(52) U.S. Cl. 294/1.3

(57) ABSTRACT

This invention is a new design for an animal waste collection and disposal device, as set forth in this specification. The claimed tool is, most often, used by pet owners to remove feces in accordance with local ordinances, and for the health and safety of all. This device allows the animal owner to remove excrement without concern for their handling of said material, and in a way that contains said material throughout their disposal process. Said device is manufacturer in a way that all parts of the main tube body are molded in a one or two mold process, and inasmuch reduce the cost of the device along with an increase to customer satisfaction Their satisfaction is driven by the devices ease of storage, weight, and ability to be kept clean. This device a truly the state of the art in the removal of pet and animal waste.

### FIELD OF THE INVENTION

This invention relates generally to devices to scoop up and dispose of waste material, or animal refuse deposited on a surface by a pet dog or other animal.

### BACKGROUND OF INVENTION

Pet waste has become a growing concern for the larger cities across this great nation. As cities grow, both human and pet populations grow. Pet waste adds to the pollution of our waters and landscape. It is a complaint of those without pets that want to share the limited park and public areas, themselves or with their children, without concern for its presence. Pet waste is their concern because of its unsanitary nature, and its ability to be tracked into cars, homes, and on clothing It has thus fallen on to the pet owners to clean-up after their pets. Some take this matter seriously; others do so at their convenience.

To motivate them, and in response to the increase in the number of pets and pet waste, many cities have imposed ordinances to make pet owners responsible for their pet's waste. Cities such as Los Angeles, New York and Chicago have imposed fines for $20 (or more) on pet owners or walkers who do not pick up after their pets in public areas or property other than their own.

Today there are solutions to ease the handling of such waste. However, the existing devices are costly, troublesome to operate, may require being under the pet at the time, and can be hard to keep clean.

### DECUSSION OF THE PRIOR ART

To best describe the prior art it must be said that virtually all of the prior art is an extension of a shovel or scoop like device at the end of a stick or pole. They lack design qualities that would notably set them apart from other devices available. For example U.S. Pat. No. 6,260,895 (Nichols, July 2001) which incorporates a bag and holder to a rack-like collection device; U.S. Pat. No. 6,190,600 (Lipniarski, February 2001) which is based on a flat bottomed scoop and its predecessor U.S. Pat. No. 6,135,520 (Miller et al,. October 2000) another scoop and cover type-device, or U.S. Pat. No. 6,113,166 (Wynn, September 2000) a scoop and bag on the end of a pole.

Basically, there are many such devices each with their own twist, but basically an expensive and clumsy approach at a scoop or a shovel at the end of a pole. Even a more innovative approach is U.S. Pat. No. 6,485,073 (Harrison, November 2002) which holds a bag in place of a scoop at the end of a pole, though possibly a little less expensive to produce, it suffers from a need to immediately recycle the material into a waste-container (potentially with the bag itself). The result is a more expensive cost of ownership and usage.

This new invention does not suffer from this previous shovel or scoop like approaches. The result is a clean-able, inexpensive way to have you pet and meet obligations of cleanup with no mess, and a lesser cost.

### BRIEF SUMMARY OF THE INVENTION

This present invention is a device for collecting pet waste as it is created, or some-time thereafter, and for doing so in a clean, safe, discrete, efficient and yet elegant manner. The present invention system provides for compact storage and enables a user to readily collect and transport the waste without personal contact. By providing a convenient waste collection system that is convenient to carry and use there will be an increase in the number of pet owners that will be responsible for their pets and associated waste.

This invention takes the form of a one or two piece molded plastic tube that incorporates a handle and a place that a plastic bag can be attached. When it is constructed through the molding process it is far less expensive to manufacture, has no moving parts, can be easily cleaned, is very light weight, is ease to operate and maintain, and can be stored with contents still bagged.

It is believed by the inventor that this invention makes pet waste and the required cleanup less of a burden both in initial purchase of the product and in the associated operating expenses.

### BRIEF DESCRIPTION OF THE SEVERAL VIEWS OF THE DRAWINGS

The object and improvement of this invention is best understood from the wording of the detailed description when taken in context with the drawings supplied here within. These drawings are detailed to be informative and may not reflect the actual item, scale, or proportions. They are not intended to be the complete representation of the invention, and should not be interpreted in a way that limits the scope of the invention otherwise detailed in other parts of this document.

This tool is designed to be manufactured of plastic or a similar material; in a single or multi-part mold process.

The interior is smooth and with minimal cavities that would otherwise trap or interfere with the collection of pet and animal debris. This characteristic is an integral part of the design.

FIG. 1 is a prospective view of minimized version of the tool.

FIG. 2 is a side view of the minimized version of that tool.

FIG. 3 is a prospective view of the elongated version of the tool.

FIG. 4 is a side view of the elongated version of the tool.

### DETAILED DESCRIPTION OF THE INVENTION

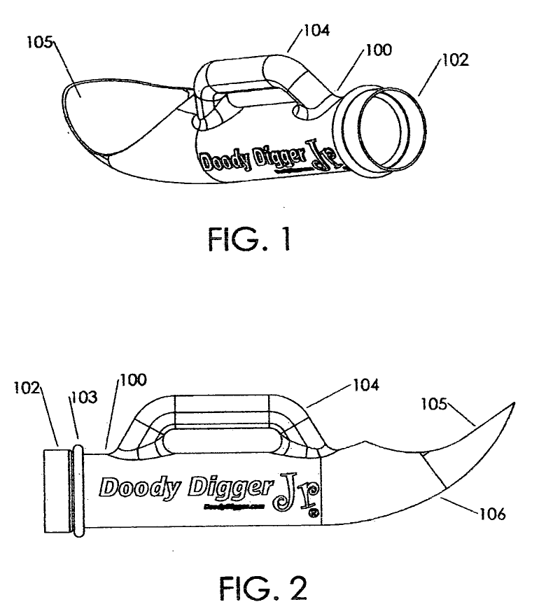

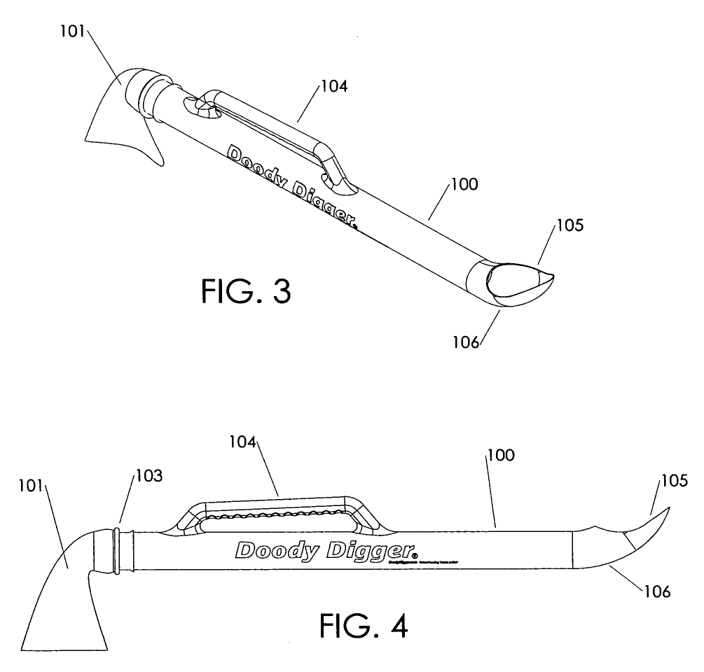

The device as seen in FIGS. 1, 2, 3, and 4 is a device made in either a one or two piece mold, that allows the entire device to be made in a way that is easy to clean without cracks and crevasses in the path of the waste material fresh or otherwise. When made in this manner the device is free from embedded and hard to remove material left from the devices use. Said material is likely to build up over time, but since the device is made of an extremely non-porous material it will easily clean-up with a garden hose.

The device in its various forms as shown in FIGS. 1, 2, 3, and 4 includes a bag retainer [102] that allows a plastic bag [101] to be temporarily attached to the tube [100] using an rubber retaining band [103] (rubber band, O-Ring, or similar rubber product) to trap the plastic bag between the retaining band and the tube itself. Such a bag retainer [102] prevents the retaining band [103] from rolling off the tube the end of the tube and aids in the control of the retained plastic bag [101].

The device in its various forms as shown in FIGS. 1, 2, 3, and 4 includes an embedded handle [104] that is incorporated into the mold so that is can be made for a substantially reduced cost. Further, because the handle [104] is so incorporated areas and edges are unlikely to allow debris to form and accumulate. Such is a value added feature with no added cost to the manufacturer.

The device in its various forms as shown in FIGS. 1, 2, 3, and 4 includes an integrated scoop [105] and angular adapter [106] fixed to an angle that places the scoop in a usable position to effect the best user ergonomics.

Lastly, by using a non-porous plastic (such as HDPE, high density polyethylene) which is most suitable for plastic molding processes (such as a Blow Mold) a tube is created that is extremely easy to clean, light weight, wear-resistant and best of all inexpensive to manufacture and ship.

1-4. (canceled)

5. A device for the sanitary removal of animal or pet waste comprising of:
A. a tubular body that is machined, cast, molded, or otherwise made from a material from the group of plastics or of a similar substance that can be smooth, plain, and unadorned or have a picture, logo, any combination of letters and/or numbers, or any other ornamental design machined, cast, molded, or otherwise incorporated into or on the side that is visible to the human eye, but is smooth, plain, and unadorned on the inside to allow the animal or pet waste to slide, glide, or run across it; and
B. a rounded shovel that is machined, cast, molded, or otherwise made from said material and that is attached at or otherwise incorporated into one end of said tubular body; and
C. a raised edge or similar device or mechanism that is machined, cast, molded, or otherwise made from said material and that is attached at or otherwise incorporated into the end of said tubular body that is opposite from the end at which said rounded shovel is attached at or incorporated into; and
D. an o-ring, rubber band, or similar object that in some manner substantially secures a bag made of plastic, cloth, or other material above said raised edge or similar device or mechanism; and
E. a grip handle that is machined, cast, molded, or otherwise made from said material and that is situated in relation to said tubular body, said rounded scoop, and said raised edge or similar device or mechanism so that a human hand may grasp said grip handle to maneuver said rounded shovel underneath the animal or pet waste, and to move said tubular body upwards then downwards in a teeter-totter like motion so that the animal or pet waste slides, glides, or runs down said tubular body from the end with said rounded shovel to the end with said raised edge or similar device or mechanism and into said bag.

6. Said tubular body in claim #5 at a length that the pet owner may easily and comfortably carry and use said device when walking his/her pet.

7. Said tubular body in claim #5 elongated so that the pet owner may easily pickup after his/her pet while standing upright.
